(19) United States
(12) Patent Application Publication
(10) Pub. No.: US 2006/0232655 A1
(43) Pub. Date: Oct. 19, 2006

(54) Electrostatic actuator, liquid-jet head, liquid-jet apparatus, device including electrostatic actuator, method for manufacturing liquid-jet head

(76) Inventors: Masahiro Fujii, Shiojiri (JP); Katsuji Arakawa, Chino (JP)

Correspondence Address: HARNESS, DICKEY & PIERCE, P.L.C., P.O. BOX 828, BLOOMFIELD HILLS, MI, 48303, US

(21) Appl. No.: 11/404,026

(22) Filed: Apr. 13, 2006

(30) Foreign Application Priority Data
Apr. 15, 2005 (JP) 2005-117874

(51) Int. Cl. B41J 2/39

(52) U.S. Cl. 347/141

(57) ABSTRACT

An electrostatic actuator includes a silicon diaphragm, an opposing electrode opposing the diaphragm with intervention of a gap therebetween, and an insulating layer formed on a surface of the diaphragm, opposing the opposing electrode. A voltage is applied between the diaphragm and the opposing electrode. The insulating layer has a laminated structure including a dielectric layer formed of a material having a higher relative dielectric constant than silicon oxide, on the diaphragm, and a surface layer exhibiting higher reduction in surface charge density than that of the dielectric layer, formed on the dielectric layer.

The entire disclosure of Japanese Patent Application No. 2005-117874, filed Apr. 15, 2005, is expressly incorporated by reference herein.

### BACKGROUND OF THE INVENTION

1. Field of the Invention

The present invention relates to an electrostatic actuator, a liquid-jet head, a liquid-jet apparatus, a device including the electrostatic actuator, and methods for manufacturing the liquid-jet head.

2. Description of the Related Art

Ink jet recording apparatuses have many advantages. For example, they can print at high speed, record with an extremely low noise level, use various types of ink, and use inexpensive plain paper. Among the ink jet recording apparatuses, so-called ink-on-demand ink jet recording apparatuses, which discharge ink droplets only when recording is needed, are mainstream in recent years. The ink-on-demand ink-jet recording apparatuses have the advantage that ink droplets unnecessary for recording do not have to be recovered.

The ink-on-demand ink-jet recording apparatus includes a so-called electrostatically actuated ink-jet recording apparatus in which ink droplets are discharged by actuating means using electrostatic force, a so-called piezoelectrically actuated ink-jet recording apparatuses using a piezoelectric element (piezoelement) as actuating means, and so-called bubble jet (registered trademark) recording apparatuses using a heater element or the like.

In the electrostatically actuated ink-jet recording apparatus, a diaphragm and an opposing electrode (may also be referred to as an individual electrode) are electrically charged so that the diaphragm is drawn toward the opposing electrode to be bent. The mechanism that is actuated by electrically charging such two members in a small apparatus is generally called an electrostatic actuator. In general, an apparatus including the electrostatic actuator, such as an ink jet recording apparatus, has an silicon oxide insulating film for preventing dielectric breakdown and short-circuiting between the electrically charged diaphragm and opposing electrode, as disclosed in, for example, Japanese Unexamined Patent Application Publication No. 11-165413.

Unfortunately, the silicon oxide insulating film is affected by residual charge on its surface, so that the electrostatic attraction force is not stabilized and the actuator thus cannot ensure stable actuation. In addition, if the thickness of the insulating film is increased, the electrostatic attraction force decreases, and it becomes difficult to downsize the electrostatic actuator and to assemble it with high density. Furthermore, when a board having the diaphragm is bonded to a board having the opposing electrode, the bonding strength decreases or bonding failure occurs, caused by the insulating film.

### SUMMARY

Accordingly, an advantage of some aspects of the present invention is to provide an electrostatic actuator in which the effect of residual charge between a diaphragm and an opposing electrode is reduced to ensure stable actuation. Another advantage of some aspects of the present invention is to provide a downsized electrostatic actuator whose actuation voltage is reduced and which exhibits high actuation durability. Still another advantage of some aspects of the present invention is to enhance the bonding strength between a board having an insulating layer and a board having the opposing electrode when they are bonded. The invention also proposes a liquid-jet head and a liquid-jet apparatus, each including the electrostatic actuator, a device including the electrostatic actuator, and a method for manufacturing the liquid-jet head.

According to an aspect of the present invention, there is provided an electrostatic actuator. The electrostatic actuator includes a diaphragm, an opposing electrode opposing the diaphragm with a gap therebetween, and an insulating layer formed on the surface opposing the opposing electrode of the diaphragm. A voltage is applied between the diaphragm and the opposing electrode. The insulating layer has a laminated structure including a dielectric layer formed of a material having a larger relative dielectric constant than silicon oxide, on the diaphragm, and a surface layer exhibiting higher reduction in surface charge density than that of the dielectric layer formed on the dielectric layer.

This structure can reduce the effect of the residual charge on the surface of the insulating layer constituting a surface of the diaphragm, and thus provide an electrostatic actuator capable of stable actuation. The dielectric layer increases the dielectric constant of the insulating layer. Accordingly, even a thin insulating film can have a high withstand voltage, and the electrostatic voltage can be increased. Consequently, the actuation voltage of the actuator can be reduced while a withstand voltage required between the diaphragm and the opposing electrode is ensured, and the resulting electrostatic actuator can be small and superior in actuation durability.

The dielectric layer may be made of any material having a high relative dielectric constant, such as aluminium oxide, silicon oxynitride, tantalum oxide, hafnium silicate nitride, and hafnium silicate oxynitride.

The surface layer may be made of silicon oxide or silicon nitride.

Preferably, surfaces defining the gap are subjected to hydrophobic treatment. Consequently, accumulation of the residual charge can be suppressed.

According to another aspect of the present invention, a liquid-jet head including any of the above described electrostatic actuators is provided. In the liquid-jet head, the electrostatic actuator is constituted by a cavity board having the diaphragm and an electrode board having the opposing electrode, bonded to the cavity board, the diaphragm constituting a bottom surface of a liquid discharge chamber for containing liquid to be discharged.

According to another aspect of the present invention, a liquid-jet apparatus including the above described liquid-jet head is provided.

The present invention is also directed to a device including any of the above described electrostatic actuator.

The apparatus and the device can produce the same effect as the electrostatic actuator.

According to another aspect of the present invention, there is provided a method for manufacturing a liquid-jet head. The method includes the insulating layer forming step, a first bonding step, a cavity board etching step and a second bonding step. In the insulating layer forming step, a dielectric layer of a material having a higher relative dielectric constant than that of silicon oxide is formed on the surface of a cavity board where a diaphragm is to be formed and then, a surface layer exhibiting higher reduction in surface charge density than the dielectric layer is formed on the surface of the dielectric layer, thereby forming a laminated insulating layer on the cavity board. In the first bonding step, the cavity board having the insulating layer is bonded to an electrode board having an opposing electrode formed in a groove, in such a manner that the region of the cavity board where the diaphragm is to be formed opposes the opposing electrode with intervention of a space in the groove therebetween. In a cavity board etching step, the cavity board bonded to the electrode board is etched to form a liquid discharge chamber including the diaphragm. In the second bonding step, a nozzle board is bonded to the surface of the cavity board opposite the electrode board.

The invention is also directed to another method for manufacturing liquid-jet head. The method includes a insulating layer forming step, cavity board etching step, a first bonding step and second bonding step. In the insulating layer forming step, a dielectric layer of a material having a higher relative dielectric constant than silicon oxide, on the surface of a cavity board where a diaphragm is to be formed and then, a surface layer exhibiting higher reduction in surface charge density than the dielectric layer is formed on the surface of the dielectric layer, thereby forming a laminated insulating layer on the cavity board. In the cavity board etching step, the cavity board having the insulating layer is etched to form a liquid discharge chamber including the diaphragm. In the first bonding step, the cavity board having the liquid discharge chamber is bonded to an electrode board having an opposing electrode in a groove, in such a manner that the diaphragm opposes the opposing electrode with intervention of a space in the groove therebetween. Then, in the second bonding step a nozzle board is bonded to the surface of the cavity board opposite the electrode board.

These methods can reduce the effect of residual charge on the surface of the insulating layer, and thus manufacture an electrostatic actuator capable of stable actuation. The methods can reduce the actuation voltage of the actuator while a withstand voltage required between the diaphragm and the opposing electrode is ensured, and thus manufacture a downsized electrostatic actuator superior in actuation durability.

Preferably, the cavity board is a silicon substrate whose surface is doped with boron, and the surface doped with the boron of the silicon substrate is formed into the diaphragm. The boron-doped surface can be used as etch stop when the silicon substrate is etched to form the bottom surface of the liquid discharge chamber, and thus the diaphragm can be easily formed.

The surface of the surface layer may be activated with the hydroxy group before the first bonding step, thereby increasing the adhesion between the board having the insulating layer and the board having the opposing electrode.

Surfaces defining the space in the groove may be subjected to hydrophobic treatment after the first bonding step, thereby further reducing the accumulation of residual charge.

### BRIEF DESCRIPTION OF THE DRAWINGS

FIG. 1 is a general longitudinal sectional view of a liquid-jet head including an electrostatic actuator according to a first embodiment of the present invention;

FIG. 2 is a structural schematic diagram of the electrostatic actuator according to the first embodiment;

FIGS. 3A to 3E are process views of a method for manufacturing the liquid-jet head according to the first embodiment;

FIGS. 4A to 4D are process views of steps following the step shown in FIG. 3E;

FIG. 5 is a perspective view of a liquid-jet apparatus including an electrostatic actuator of the present invention according to a second embodiment of the present invention; and

FIG. 6 is a perspective view of a device including an electrostatic actuator according to a third embodiment of the present invention.

### DESCRIPTION OF THE PREFERRED EMBODIMENTS

### First Embodiment

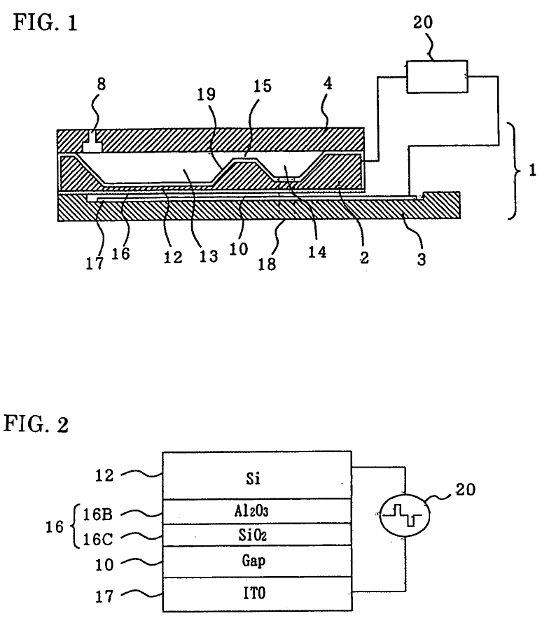

FIG. 1 is a general longitudinal sectional view of a liquid-jet head including an electrostatic actuator according to a first embodiment of the present invention. In FIG. 1, an actuation circuit 20 to which a voltage is applied is schematically shown. The liquid-jet head 1 mainly includes a cavity board 2, an electrode board 3, and a nozzle board 4 that are joined together.

The cavity board 2 is made of, for example, single crystal silicon, and has a plurality of recesses serving as liquid discharge chambers 13 whose bottoms are formed into diaphragms (or vibrating films) 12. The discharge chambers 13 are arranged parallel to each other in the direction perpendicular to the sheet of FIG. 1. The diaphragms 12 defining the bottoms of the discharge chambers 13 are formed thin, by etch-stop in wet etching after diffusing boron (B) into a surface of a silicon substrate. The cavity board 2 also has a recess serving as a reservoir 14 for supplying ink or the like to each discharge chamber 13, and narrow grooves serving as orifices 15 that allow the reservoir 14 to communicate with each discharge chamber 13. In the liquid-jet head 1 shown in FIG. 1, the reservoir 14 is defined by a single recess, and the orifices 15 are provided for the respective discharge chambers 13. The orifices 15 may be formed in the nozzle board 4.

The surface of the cavity board 2 on the side of the bonded electrode board 3 is provided with an insulating layer 16 for preventing the dielectric breakdown or short-circuit of the liquid-jet head 1 during actuation. The insulating layer 16 will be described in detail later. The surface of the cavity board 2 on the side of the bonded nozzle board 4 is provided with an anti-liquid protective film 19. The anti-liquid protective film 19 prevents the liquid in the discharge chambers 13 and the reservoir 14 from etching the cavity board 2.

The electrode board 3 is made of, for example, borosilicate glass and is bonded to the cavity board 2 on the side of the diaphragms 12. The electrode board 3 has a plurality of opposing electrodes 17 opposing the diaphragms 12 with intervention of a gap 10 therebetween. The gap 10 is set in the range of, for example, 100 to 200 nm. The opposing electrodes 17 are formed of, for example, indium tin oxide (ITO) by sputtering. The electrode board 3 also has an ink supply hole 18 communicating with the reservoir 14. The ink supply hole 18 communicates with a hole formed in the bottom of the reservoir 14 so as to supply liquid, such as ink, to the reservoir 14.

The nozzle board 4 is made of silicon or the like, and is bonded to the surface of the cavity board 2 opposite the electrode board 3. The nozzle board 4 has nozzles 8 each having, for example, a cylindrical first nozzle hole and a cylindrical second nozzle hole communicating with the first nozzle hole and having a larger diameter than the first nozzle hole.

The insulating layer 16 provided on the cavity board 2 will now be described in detail. FIG. 2 is an enlarged schematic view of the electrostatic actuator of the liquid-jet head 1 shown in FIG. 1, and is more specifically an enlarged view of the diaphragm 12, the insulating layer 16, the opposing electrode 17, and the actuation circuit 20. The insulating layer 16 has a laminated structure including a dielectric layer 16B formed of a material having a higher relative dielectric constant than silicon oxide, such as aluminium oxide (Al₂O₃), on the surface of the silicon (Si) diaphragms 12, and a surface layer 16C on the surface of the dielectric layer 16B, formed of a material, such as silicon oxide (SiO₂), that exhibits a higher reduction in surface charge density than the dielectric layer 16B and that, accordingly, can reduce the surface charge density of the insulating layer 16.

The insulating layer 16 having such a laminated structure increases its own dielectric constant due to the dielectric layer 16B. Accordingly, the thickness of the insulating layer can be reduced and the electrostatic attraction force is increased. Thus, the resulting actuator can perform low-voltage actuation and allow high density packaging. Furthermore, the surface layer 16C reduces the charge density and the residual charge on the surface of the insulating layer 16 to prevent the diaphragms 12 from adhering to the opposing electrodes 1. Thus, the electrostatic actuator can realize stable actuation.

The dielectric layer 16B is made of a material having a higher relative dielectric constant than the relative dielectric constant (4.4) of silicon oxide, which is conventionally used for insulating films. Such materials include aluminium oxide (Al₂O₃), silicon oxynitride (SiON), tantalum oxide (Ta₂O₅), hafnium silicate nitride (HfSiN), and hafnium silicate oxynitride (HfSiON). These materials, which are insulative and generally called High-k materials, can reduce the equivalent oxide thickness (ETO) of the insulating layer, ensuring a desired withstand voltage, and can increase electrostatic voltage. In addition, hafnium-aluminum oxide (HfAlOx), hafnium oxide (HfOx), or the like may be used as the material of the dielectric layer 16B.

The surface layer 16C can be formed by depositing silicon oxide or silicon nitride. The surface of the surface layer 16C may be treated to increase the density of hydroxy groups (activate the surface with the hydroxy group). This treatment facilitates the bonding between the surface layer 16C and the electrode board 3. The inner surfaces (inner walls) defining the gap 10 may be subjected to hydrophobic treatment with a silane-based or fluorine-based agent. This treatment replaces the hydroxy group with a hydrophobic group to prevent adsorbed water molecules from electrically charging, thus further reducing the accumulation of residual charge. In this instance, the reduction in surface charge density of the surface layer 16C depends on the density of hydroxy groups. The hydrophobic treatment to the inner surfaces of the gap 10 replaces the hydroxy groups at their surfaces with hydrophobic groups and thus eliminates the effect of electrical charges on the absorbed water molecules to prevent the accumulation of the residual charge. Thus, the surface charge density is reduced. The ease of reduction in surface charge density depends on how easily the hydroxy groups on the surfaces are replaced with hydrophobic groups by hydrophobic treatment. A suitable material for such a surface layer 16C is silicon oxide.

When the diaphragm 12 has a thickness of, for example, about 2 μm, the dielectric layer 16B and the surface layer 16C may have thicknesses of about 80 nm and about 10 nm, respectively. However, these thicknesses may be appropriately set in view of the increase of the withstand voltage and electrostatic voltage that are required of the insulating layer 16.

How the liquid-jet head 1 shown in FIG. 1 operates will now be described. The cavity board 2 and each opposing electrode 17 are connected to an actuation circuit 20. On applying a pulsed voltage between the cavity board 2 and an opposing electrode 17 from the actuation circuit 20, the opposing electrode 17 draw the diaphragm 12, so that the surface layer 16C over the surface of the diaphragm 12 adheres to the opposing electrode 17. Consequently, a negative pressure occurs inside the discharge chamber 13, and the liquid, such as ink, in the reservoir 14 flows into the discharge chamber 13. If the voltage applied between the cavity board 2 and the electrode 17 is removed at the timing when the ink fed into the discharge chamber 13 starts increasing the internal pressure, the diaphragm 12 is restored to the initial position to further increase the internal pressure of the discharge chambers 13. The liquid, or ink, is thus discharged through a nozzle 8. In the electrostatic actuator thus operating, the insulating layer 16 prevents the breakdown of the actuator resulting from electrical discharge occurring at the time when the diaphragm 12 adheres to the opposing electrode 17. In addition, the surface layer 16C reduces the change in voltage generated by the residual charge.

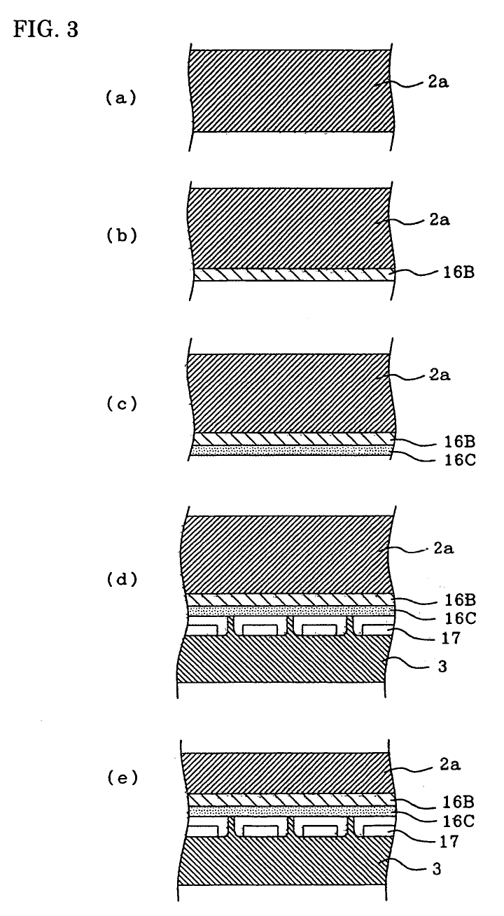

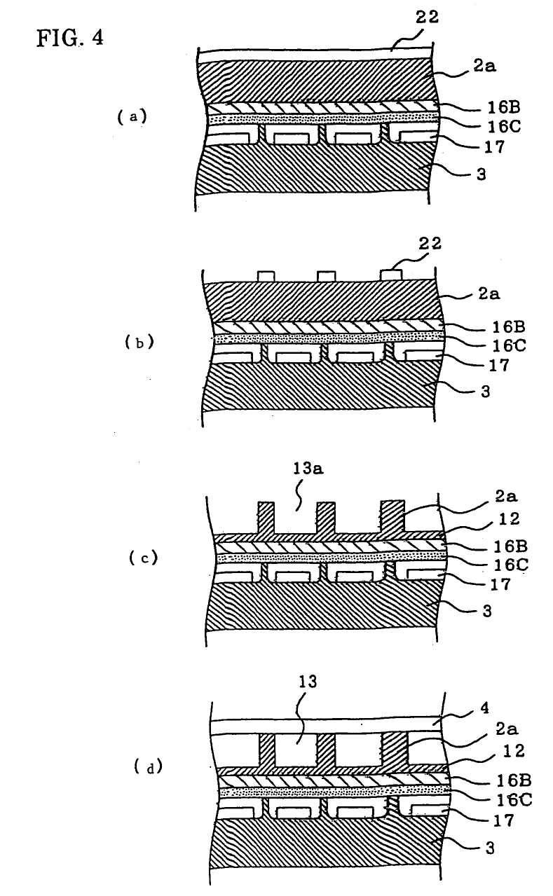

FIGS. 3A to 3E and 4A to 4D are exemplary process views of the manufacture of the liquid-jet head according to the first embodiment of the present invention. The steps of forming the cavity board 2 and the electrode board 3 are not limited to those shown in these figures.

(a) First, as shown in FIG. 3A, a silicon substrate 2a having mirror-finished surfaces and a thickness of, for example, 525 μm, is prepared. Then, one surface of the silicon substrate 2a is doped with boron to form a boron-doped layer with a thickness of, for example, about 2 μm. The boron-doped layer is intended as the diaphragms 12.

(b) Turning to FIG. 3B, the dielectric layer 16B is formed on the surface of the boron-doped layer of the silicon substrate 2a by electron-cyclotron-resonance (ECR) sputtering or plasma CVD of aluminium oxide or silicon oxynitride.

(c) Subsequently, turning to FIG. 3C, the surface layer 16C is formed on the surface of the dielectric layer 16B to obtain the laminated insulating layer 16. The surface layer 16C is formed so as to form a dense silicon oxide layer by TEOS plasma CVD or the like. The surface of the resulting surface layer 16C may be subjected to surface treatment to activate it with the hydroxy group by oxygen plasma exposure, UV exposure, or washing with a nitric acid-based cleaning liquid and subsequent conditioning so that the surface can be easily bonded to the electrode board 3.

(d) Turning to FIG. 3D, the cavity board 2 having the insulating layer 16 is bonded to the electrode board 3 having the opposing electrodes 17, which correspond to the diaphragms 12 that are to be formed in the cavity board 2, by, for example, anodic bonding. The anodic bonding can be performed by, for example, applying a voltage of about 800 V between the silicon substrate 2a connected to a positive electrode and the electrode board 3 connected to a negative electrode, with the electrode board 3 heated at, for example, 360° C.

The surface of the surface layer 16C may be subjected to treatment to increase the density of hydroxy groups (to activate the surface with the hydroxy group) before anodic bonding. This treatment facilitates the bonding between the surface layer 16C and the electrode board 3. Also, the inner surfaces defining the gap 10 may be subjected to hydrophobic treatment with a silane-based or fluorine-based agent after the anodic bonding. This treatment is effective in suppressing the accumulation of residual charge.

The electrode board 3 can be prepared from a borosilicate glass substrate. The borosilicate glass substrate is etched to form recesses by a hydrofluoric acid solution using, for example, a gold-chromium etching mask. Then, the ITO opposing electrodes 17 are formed in the recesses by sputtering.

(e) Turning then to FIG. 3E, the thickness of the entire silicon substrate 2a bonded to the electrode board 3 is reduced to about 140 μm by, for example, mechanical grinding. Then, preferably, the surface degraded by the processing is removed by light etching with potassium hydroxide or the like. Instead of the mechanical grinding, wet etching using potassium hydroxide can be performed to reduce the thickness of the silicon substrate 2a.

(f) Turning to FIG. 4A, a silicon oxide film 22 is formed to a thickness of, for example, about 1.5 μm over the entire upper surface (surface opposite the electrode board 3) of the silicon substrate 2a by TEOS plasma CVD.

(g) Turning to FIG. 4B, the silicon oxide film 22 is patterned to form a resist pattern for forming the recesses for the discharge chambers 13, the reservoir 14, and the orifices, by etching. In this instance, the regions for the recesses of the silicon oxide film are removed.

(h) Turning then to FIG. 4C, the silicon substrate 2a is subjected to anisotropic wet etching with potassium hydroxide aqueous solution or the like to form the recesses 13a intended as the discharge chambers 13, the recess (not shown) intended as the reservoir 14, and the recesses (not shown) intended as the orifices. Subsequently, the silicon oxide resist pattern is removed. For the wet etching, two-step etching is preferably performed. For example, solution of 35% by weight potassium hydroxide in water is first used, and then solution of 3% by weight potassium hydroxide in waster is used. Such a process can prevent the surfaces of the diaphragms 12 from getting rough. In the etching process, the previously formed boron-doped layer serves as an etch stop, and the left boron-doped layer serves as the diaphragms 12.

Then, the anti-liquid protective film (not shown in the process views, but designated by reference numeral 19 in FIG. 1) made of silicon oxide is formed with a thickness of, for example, 0.1 μm over the surface having the recesses of the silicon substrate 2a by, for example, CVD.

(i) Turning then to FIG. 4D, the nozzle board 4 is bonded to the surface of the silicon substrate 2a (cavity board 2) opposite the electrode board 3 with an adhesive. In this instance, the nozzle board 4 has been provided with the nozzles 8 in advance by dry etching using, for example, inductively coupled plasma (ICP) discharge.

Finally, the resulting board consisting of the cavity board 2, the electrode board 3 and the nozzle board 4 bonded together is diced (cut) into liquid-jet heads 1.

In the above-described process, the following steps are performed in this order: the insulating layer forming step of forming the insulating layer 16 on the surface of a silicon substrate 2a where the diaphragms 12 are to be formed; the first bonding step of bonding the silicon substrate 2a having the insulating layer 16 to the electrode board 3 having the opposing electrodes 17 corresponding to the diaphragms 12 in such a manner that the regions intended as diaphragms 12 oppose the respective opposing electrodes 17; the cavity board 2 forming step of forming the discharge chambers 13 including the diaphragms 12, the reservoir 14 and the like by etching the silicon substrate 2a bonded to the electrode board 3; and the second bonding step of bonding the nozzle board 4 to the cavity board 2. In this process, the discharge chambers 13, the reservoir 14, and the other recesses are formed by etching the silicon substrate 2a bonded to the electrode board 3. This makes it relatively easy to handle the silicon substrate 2a, which is liable to be broken.

The liquid-jet head 1 may be manufactured by the following steps in this order: the insulating layer forming step of forming the insulating layer 16 on the surface of the silicon substrate 2a where the diaphragms 12 are to be formed; the cavity board 2 forming step of etching the silicon substrate 2a having the insulating layer 16 to form the discharge chambers 13 including the diaphragms 12 and the reservoir 14 or the like; the first bonding step of bonding the cavity board 2 having the discharge chambers 13 to the electrode board 3 having the opposing electrodes 17 corresponding to the diaphragms 12 in such a manner that the diaphragms 12 opposes the opposing electrodes 17; and the second bonding step of bonding the cavity board 2 to the nozzle board 4.

These processes allows the resulting electrostatic actuator to reduce the effect of residual charge on the surface of the insulating layer 16 constituting the surfaces of the diaphragms 12, and thus to ensure stable actuation. Also, the processes can manufacture a downsized electrostatic actuator with a superior actuation durability, which can ensure a required withstand voltage between the diaphragms 12 and the opposing electrodes 17 and thus reduce the actuation voltage of the actuator.

### Second Embodiment

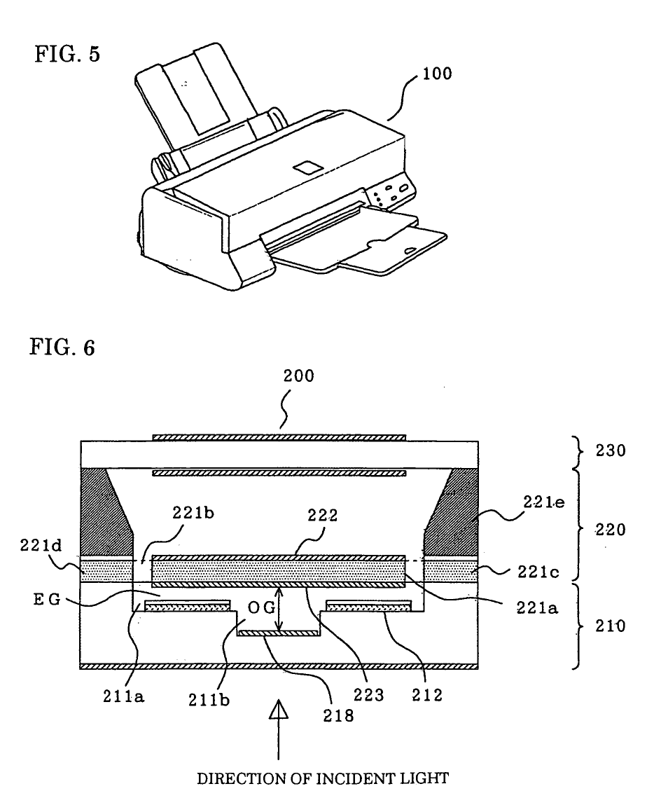

FIG. 5 is a perspective view of a liquid-jet apparatus according to a second embodiment, including the liquid-jet head according to the first embodiment. The liquid-jet apparatus 100 shown in FIG. 5 is an ink-jet printer that discharges ink as liquid droplets.

In the liquid-jet apparatus 100, the electrostatic actuator and the liquid-jet head installed in the apparatus reduce the effect of the residual charge at the electrostatic actuator. Consequently, the liquid-jet apparatus can precisely discharge ink by stable actuation. In addition, the liquid-jet apparatus 100 exhibits superior actuation durability even if it is downsized.

In addition to the ink-jet printer shown in FIG. 5, the liquid-jet head 1 of the first embodiment can be applied to liquid-jet apparatuses for, for example, forming matrix patterns of color filters, forming light-emitting portions of organic EL display devices, or discharging liquid samples of the living body, by changing the liquid discharged.

### Third Embodiment

The electrostatic actuator is applied not only to liquid-jet heads, but also to a variety of devices. FIG. 6 is a perspective view of a device including the electrostatic actuator according to a third embodiment of the present invention. The device shown in FIG. 6 is a tunable filter 200. The tunable filter 200 includes an actuation electrode portion 210, a movable portion 220, and packaging portion 230. The tunable filter filters a light rays having a specific wavelength from incident light on the basis of the variation in the position of the movable portion 220 and emits those light rays.

The movable portion 220 includes a movable member 221a having a movable reflecting surface 223, moving in the direction perpendicular to the surface of the movable reflecting surface 223, thereby transmitting a light with a predetermined wavelength and reflecting the other light; a joint 221b movably holding the movable member 221a; a support 221c; and a spacer 221e for creating a space on the opposite side to the movable reflecting surface 223. These parts are integrally formed. The movable member 221a is made of, for example, a silicon active layer having a thickness of 1 to 10 μm.

The actuation electrode portion 210 includes an actuation electrode 212 opposing the movable member 221a with an electrostatic gap EG therebetween; and a fixed reflecting surface 218 opposing the movable reflecting surface 223 with an optical gap EG therebetween, reflecting the light reflecting from the movable reflecting surface 223. The actuation electrode portion 210 is bonded to the movable portion 220 on the opposite side to the spacer 221e, in such a manner that the movable reflecting surface 223 and the fixed reflecting surface 218 oppose each other. The actuation electrode portion 210 may be made of, for example, a glass substrate.

The packaging portion 230 is bonded to the movable portion 220 at the top of the spacer 211e so as to cover the space created by the spacer 221e.

In the tunable filter 200 having the above-described structure, the movable member 221a and the actuation electrode 212 respectively correspond the diaphragm 12 and the opposing electrode 17 in the first embodiment, and constitute an electrostatic actuator. Hence, by forming the same insulating layer as in the first embodiment on the surface of the movable member 221a opposing the actuation electrodes 212, the effect of residual charge on the electrostatic actuator can be reduced. Consequently, the movable member 221a can stably move to filter light precisely. In addition, the withstand voltage and the electrostatic voltage increase, and accordingly, the tunable filter 200 can be small and exhibit superior actuation durability.

As describe above, the electrostatic actuator according to the present invention can be applied to a variety of devices, and particularly used as actuators of micromachines. For example, the electrostatic actuator can be used in the pumping portion of micro-pumps, the switching portions of optical switches, the mirror driving portions of mirror devices for controlling light direction by inclining a large number of super-small mirrors disposed in the device, and the laser-operating mirror driving potions of laser printers.

1. An electrostatic actuator comprising:
a diaphragm;
an opposing electrode opposing the diaphragm with intervention of a gap therebetween, a voltage being applied between the opposing electrode and the diaphragm; and
an insulating layer formed on a surface of the diaphragm opposing the opposing electrode,
wherein the insulating layer has a laminated structure including a dielectric layer which is formed of a material having a higher relative dielectric constant than that of silicon oxide film formed on the diaphragm, and a surface layer exhibiting higher reduction in surface charge density than that of the dielectric layer, the surface layer being
formed on the dielectric layer.

2. The electrostatic actuator according to claim 1, wherein the dielectric layer is made of a material selected from the group consisting of aluminium oxide, silicon oxynitride, tantalum oxide, hafnium silicate nitride, and hafnium silicate oxynitride.

3. The electrostatic actuator according to claim 1, wherein the surface layer is made of silicon oxide or silicon nitride.

4. The electrostatic actuator according to claim 1, wherein surfaces defining the gap are subjected to hydrophobic treatment.

5. A liquid-jet head comprising the electrostatic actuator as set forth in claim 1, wherein the electrostatic actuator is constituted by a cavity board having the diaphragm and an electrode board, bonded to the cavity board, having the opposing electrode, the diaphragm constituting a bottom surface of a liquid discharge chamber for containing liquid to be discharged.

6. A liquid-jet apparatus comprising the liquid-jet head as set forth in claim 5.

7. A device comprising the electrostatic actuator as set forth in claim 1.

8. A method for manufacturing a liquid-jet head, comprising:
an insulating layer forming step of forming a dielectric layer of a material having a higher relative dielectric constant than silicon oxide, on a surface of a cavity board where a diaphragm is to be formed, and forming a surface layer exhibiting higher reduction in surface charge density than that of the dielectric layer, on the surface of the dielectric layer, thereby forming a laminated insulating layer on the cavity board;
a first bonding step of bonding the cavity board having the insulating layer to an electrode board having an opposing electrode in a groove, in such a manner that a region of the cavity board where the diaphragm is to be formed opposes the opposing electrode with intervention of a space in the groove therebetween;
a cavity board etching step of etching the cavity board bonded to the electrode board to form a liquid discharge chamber including the diaphragm; and
a second bonding step of bonding a nozzle board to the surface of the cavity board, opposite the electrode board.

9. A method for manufacturing a liquid-jet head, comprising:
an insulating layer forming step of forming a dielectric layer of a material having a higher relative dielectric constant than silicon oxide, on a surface of a cavity board where a diaphragm is to be formed, and forming a surface layer exhibiting higher reduction in surface charge density than that of the dielectric layer, on the surface of the dielectric layer, thereby forming a laminated insulating layer on the cavity board;
a cavity board etching step of etching the cavity board having the insulating layer to form a liquid discharge chamber including the diaphragm;
a first bonding step of bonding the cavity board having the liquid discharge chamber to an electrode board having an opposing electrode in a groove, in such a manner that the diaphragm opposes the opposing electrode with intervention of a space in the groove therebetween; and
a second bonding step of bonding a nozzle board to the surface of the cavity board, opposite the electrode board.

10. The method according to claim 8, wherein the cavity board is a silicon substrate whose surface is doped with boron, and the surface doped with the boron of the silicon substrate is formed into the diaphragm.

11. The method according to claim 8, further comprising a step of activating the surface of the surface layer with the hydroxy group before the first bonding step.

12. The method according to claim 8, further comprising a step of applying hydrophobic treatment to surfaces defining the space in the groove after the first bonding step.

13. The method according to claim 9, wherein the cavity board is a silicon substrate whose surface is doped with boron, and the surface doped with the boron of the silicon substrate is formed into the diaphragm.

14. The method according to claim 9, further comprising a step of activating the surface of the surface layer with the hydroxy group before the first bonding step.

15. The method according to claim 9, further comprising a step of applying hydrophobic treatment to surfaces defining the space in the groove after the first bonding step.
